(19) United States
(12) Patent Application Publication
(10) Pub. No.: US 2005/0157344 A1
(43) Pub. Date: Jul. 21, 2005

(54) Printing data creation apparatus, printing data creation method and printing data creation program

(76) Inventor: Hiroyuki Nagashima, Fukuoka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/029,478

(22) Filed: Jan. 6, 2005

(30) Foreign Application Priority Data
Jan. 16, 2004 (JP) 2004-009297

(51) Int. Cl. G06K 15/02; H04N 1/387

(52) U.S. Cl. 358/1.18; 358/452

(57) ABSTRACT

A printing data creation apparatus capable of printing an image for which the automatic editing adjusted to an editing instruction from the user is performed. This apparatus sets an editing area on a target image, and acquires data of the paper to be used in printing. In case of receiving an instruction from the user to edit the image inside the area set on part of the target image, the apparatus determines the details of editing of the image outside the set area of the target image based on the acquired data of the paper and on the instruction. And, the apparatus creates printing data from the data of the target image based on the instruction and the determination.

### BACKGROUND OF THE INVENTION

1. Field of the Invention

This invention relates to a printing data creation apparatus, such as a printer, a facsimile and a copier, having an editing function, particularly for enlargement or reduction of an image, and relates to a printing data creation method and a printing data creation program.

2. Description of the Related Art

A printer apparatus disclosed in Japanese unexamined patent publication No. 2000-141812 is capable of saving a user from having to change the settings for the paper size, printing direction, or the like. The printer apparatus, on receiving image data, detects the paper size and printing direction for the image data. When the detection result differs from the settings, the enlargement, reduction or rotation of the image data is conducted according to the difference.

Japanese unexamined patent publication No. 11-203495 discloses an apparatus automatically changing a scale according to the paper prepared for the printer. When there is no paper in the printer that matches the estimated size of a CAD drawing, the apparatus fits the entire drawing or selected area of the drawing on the prepared paper by changing the scale. It is also capable of cutting part of the drawing, in order to fit it on the paper without changing the scale.

### SUMMARY OF THE INVENTION

Automatic editing of the image by these apparatuses does not ask a user to change papers for printing. When the user wishes an image for which desired editing is performed, it is necessary to perform the editing work using an application on a computer generally.

When the user performs the desired editing on a computer, it might not be preferable that the printer performs automatic editing. For example, in order to check a detailed sect ion on a map, even though the user enlarges part of the image, if the enlarged area is automatically reduced according to the paper, the user is not able to sufficiently check the detailed section.

Therefore, there are cases when the image editing function of the printing apparatus does not adequately function according to the editing instruction given by the user.

In order to solve the problems of the prior art described above, the object of this invention is to provide a printing data creation apparatus, printing data creation method and printing data creation program capable of conducting the image editing adjusted to an editing instruction from the user.

In order to accomplish the aforementioned object, this invention employs the construction described below.

In the printing data creation apparatus of this invention, a setting unit sets an editing area on the target image. An acquisition unit acquires data of a paper to be used in printing. When a user gives an instruction to edit an image inside an area set on the target image, a determination unit determines details of editing of an image outside the set area on the target image, based on the acquired data of the paper and the instruction. A creation unit creates printing data from data of the target image based on the instruction and the determination.

Therefore, when a user gives an instruction to edit the image inside the set area, it is possible to automatically perform the editing adjusted to the instruction.

For example, upon receiving an instruction from a user to enlarge an image inside the set area, the determination unit determines to reduce an image outside the set area according to the enlargement. Thereby, it is possible to avoid having the information of the image outside the set area from being greatly lost from the printing data due to the enlargement.

The setting of the editing area can be performed based on a specification from the user using the control unit. The area is set based on one or more points that are specified on the target image, or based on data that is specified from the data for the target image.

With this printing data creation apparatus, it is possible to include only data selected by the user from the data for the target image on the printing data. By eliminating unnecessary data for the user from the printing data, it is easier for the user to view the necessary information on the printed material.

Moreover, the printing data creation apparatus may automatically select data included on the printing data, based on a specified magnification rate for enlargement or reduction. Thereby, it is possible to provide the user with additional information, and improve the ability to view the information on the printed material.

Furthermore, it is also possible for the printing data creation apparatus to judge whether or not to edit the layout of the image on the paper, based on the format of the data of the target image. When editing the layout, the printing data creation apparatus sets an area based on the data for the target image. And even when there is no instruction from the user to edit the image inside the set area, the printing data creation apparatus creates printing data based on the editing instruction for editing the layout.

The user is able to check and give instructions for at least editing of the layout before printing even when giving no instruction for editing the image inside the set area. For example, for data such as data in HTML (Hyper Text Markup Language), there is no information indicating page breaks. In such a case, there is a possibility that one drawing will be divided up over a plurality of sheets of paper. By giving an instruction for editing the layout based on the data format before printing, it is possible to avoid unnecessary printing.

When editing the layout, it is possible for the printing data creation apparatus to set layout candidates, based on the settings of the area and data of the paper. In this case, the printing data creation apparatus creates printing data based on the layout selected from among the candidates. By doing this, it is possible for the user to easily give editing instructions for editing the layout.

From another aspect, this invention provides a printing data creation method that corresponds to the printing data creation apparatus described above. This printing data creation method performs a step of setting an editing area on the target image, and a step of acquiring data of the paper to be used in printing. In the case of receiving an instruction from the user to edit the image inside the area set on a part of the target image, the step of determining the details of the editing of the image outside the area set on the target image is conducted based on the acquired data of the paper and the editing instruction. And, the step of creating printing data from the data of the target image is conducted based on the editing instruction and the determination.

Furthermore, from yet another aspect, this invention provides a printing data creation program that corresponds to the printing data creation method. This printing data creation program causes a computer to execute the steps of the printing data creation method. The computer functions as the printing data creation apparatus of this invention.

The printing data creation program is a series of instructions for a general-purpose computer or a built-in system, and by expressing these instructions using an electrical signal, it is possible to provide the program via an electrical communication line such as the Internet. Also, in order to distribute or sell the program as a product, it is possible to record the program onto a computer readable recording medium such as a CD-ROM or DVD-ROM.

By employing the construction described above, this invention makes it possible to conduct the image editing adjusted to an editing instruction from the user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing showing the hardware construction of the printer according to an embodiment of the invention.

FIG. 2 is a block diagram showing the functions of the printing data creation apparatus according to an embodiment of the invention.

FIG. 3 is a flowchart showing the procedure of the printing data creation method according to an embodiment of the invention.

FIG. 4 is a drawing showing an example of a specification screen.

FIG. 5 is a drawing showing an example of a target image.

FIG. 6 is a drawing showing an example of a set area in the target image.

FIG. 7 is a drawing showing an example of an edited image.

FIG. 8 is a drawing showing a different example of an edited image.

FIG. 9 is a drawing showing a comparison between the target image and edited image.

FIG. 10 is a drawing showing an example of an edited image when data is selected.

FIG. 11 is a drawing showing an example of an edited image when data corresponding to a magnification rate is selected automatically.

FIG. 12 is a drawing showing the hardware construction of a computer according to an embodiment of the invention.

FIG. 13 is a drawing showing an example of a layout-specification screen.

FIG. 14 is a drawing showing a selection screen for selecting layout candidates.

### DESCRIPTION OF THE PREFERRED EMBODIMENT

In this embodiment, the invention is embodied as a printer that is capable of printing data that is recorded on a SD (Secure Digital) card.

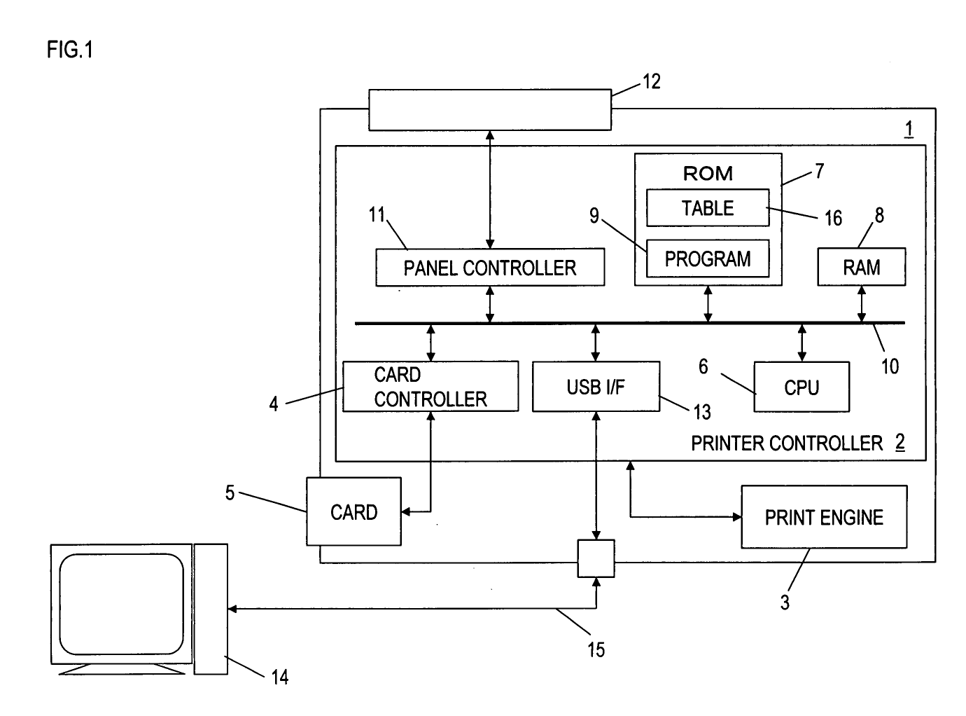

As shown in FIG. 1, this printer 1 comprises a printer controller 2 and print engine 3. The printer controller 2 is a circuit that controls the entire printer 1, and when data to be printed is input, creates printable data from the data and outputs it to the print engine 3. The print engine 3 prints the created printing data on paper.

In the printer controller 2, a card controller 4 is located. The card controller 4 controls access of a SD card 5 that is mounted in the printer 1 such that it can be removed. The card controller 4 reads data of various formats from the SD card 5 according to instructions from a CPU (Central Processing Unit) 6.

For example, the card controller 4 reads data in various formats such as XML (extensible Markup Language) format like SVG (Scalable Vector Graphics), HTML format, JPEG (Joint Photographic Expert Group) format, bitmap format, text format, etc.

The CPU 6 controls the circuits connected by a bus 10 according to instructions from a control program 9 that is read to RAM (Random Access Memory) 8 from ROM (Read Only Memory) 7, and by doing that controls the printer controller 2. Here, the CPU 6 performs interpretation of the input data, creation of printing data, editing of the image, and other image processing.

In addition to the card controller 4, ROM 7 and RAM 8, a panel controller 11 is also connected to the bus 10. The panel controller 11 receives data from the CPU 6 and controls the control panel 12.

The control panel 12 uses a touch panel, hardware keys, and LCD (Liquid Crystal Display) to display screens necessary for control, screens showing the status of the printer and the image to be printed. The buttons, cursor keys, number keys, and the like on the control panel 12 are used by the user to input instructions to the printer 1 such as instructions for printing or editing an image.

When the user mounts a SD card 5 into the printer 1, a list of the data recorded on the SD card 5 is displayed on the control panel 12. When the user enters an instruction to print data that is selected from this list, the CPU 6 reads the data from the SD card 5 to the RAM 8 via the bus 10, and creates printing data from the data. By outputting this data to the print engine 3, the data recorded on the SD card 5 is printed.

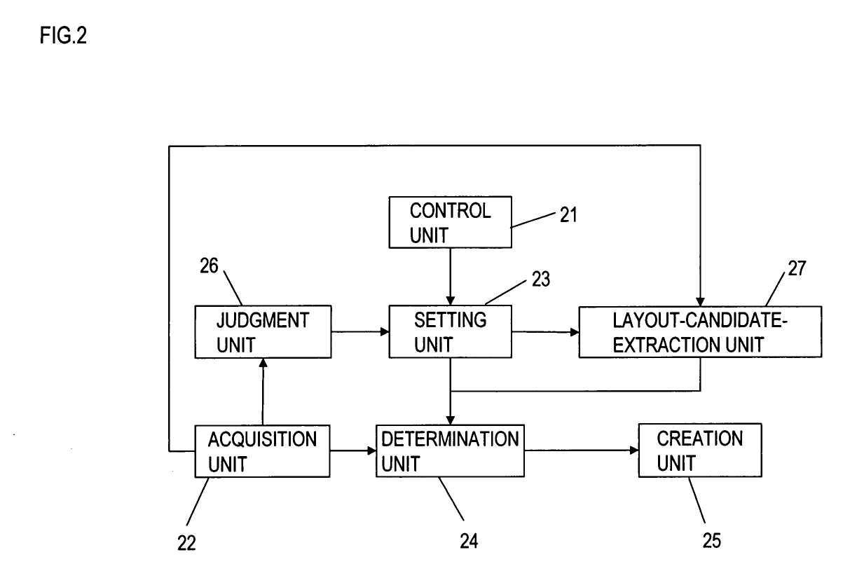

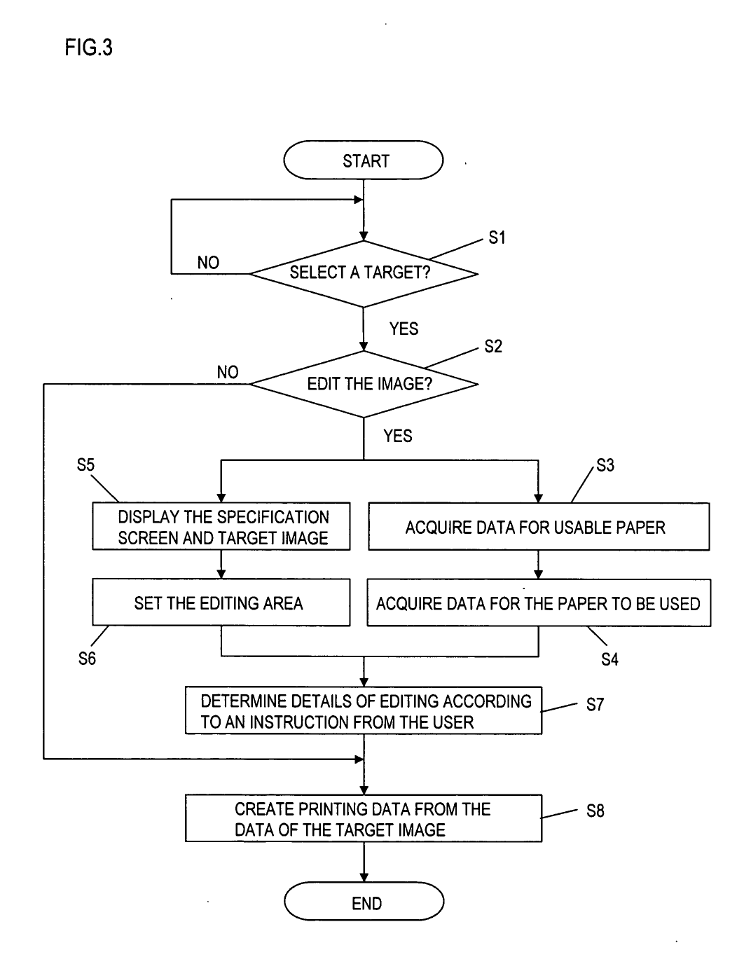

It is possible to perform editing such as enlarging, reducing, rotating or moving an image that corresponds to the data recorded on the SD card 5 using the printer 1. When editing the target image using the printer 1, the program 9 makes this printer 1 function as the units of the printing data creation apparatus shown in FIG. 2, and to execute the procedure of the printing data creation method shown in FIG. 3.

In this printing data creation apparatus, the user uses the control unit 21 to give instructions for editing the target image, and to give other instructions to the printing data creation apparatus. Here, the control panel 12 of the printer 1 is used as the control unit 21.

An acquisition unit 22 acquires data related to the paper that is used in printing. The printing data creation apparatus can automatically determine the paper to be used in printing from the size of paper that is available for the printing data creation apparatus. Also, it is possible for the printing data creation apparatus to provide the user with paper choices based on the usable paper sizes, and to determine the paper to be used in printing according to the selection result. After the paper to be used in printing has been determined, the acquisition unit 22 acquires data related to the paper. The acquired data is the size and direction of that paper. Here, the CPU 6 performs this acquisition function according to an instruction from the program 9.

As shown in FIG. 3, when data in SVG format is selected from the list as the target to be printed for example (S1), and the user gives an instruction from the control panel 12 to edit the map image corresponding to the data before printing (S2), the CPU 6 follows an instruction from the program 9 and acquires the size and direction of the paper stored in the standard cassettes and optional cassettes of the printer 1 from the print engine (S3). Based on the acquired paper sizes and directions, selection choices are displayed on the control panel 12. When the user specifies a paper size and direction to be used in printing from among the selection choices displayed on that display screen, the CPU 6 acquires data related to the paper to be used in printing based on the specification (S4).

In addition to acquiring this kind of data related to the paper, in the printing data creation apparatus, when there is an instruction from the user to edit the image, a setting unit 23 sets an editing area in the target image. In the case where the user uses the control unit 21 to specify the editing area, the setting unit 23 sets the editing area on the target image according to the instruction. Here, the CPU 6 performs the setting function according to an instruction from the program 9.

The CPU 6 reads the screen data for specifying the editing area from the ROM 7, and displays the screen on the control panel 12. Also, the CPU 6 interprets the SVG format data and displays a rasterized image according to that result (S5).

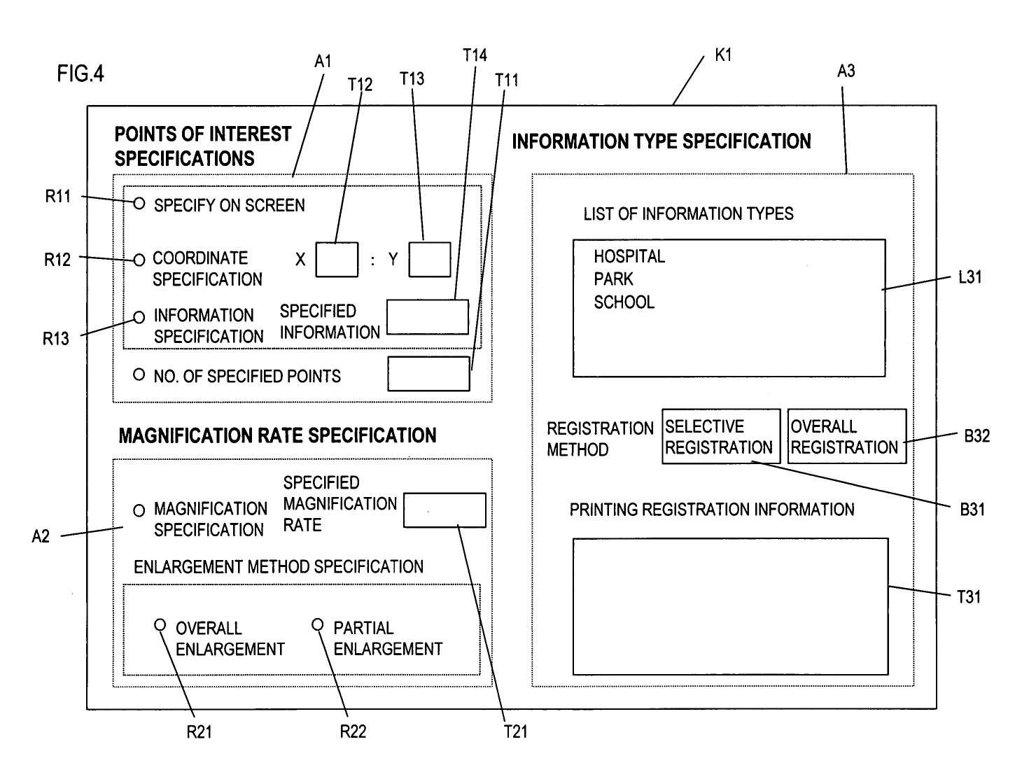

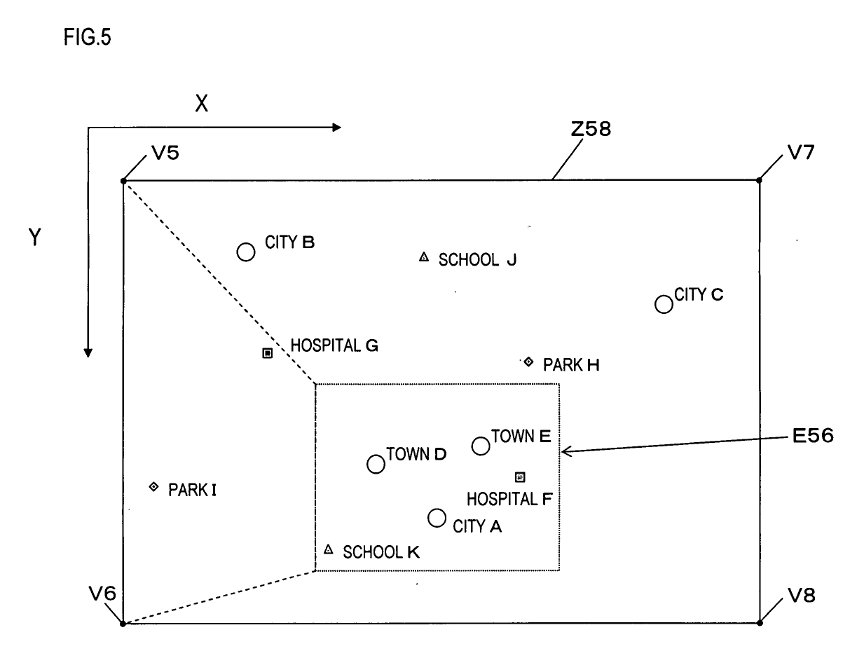

FIG. 4 is an example of a specification screen, and FIG. 5 is an example of the target image. The specification screen K1 of FIG. 4 can be used to specify an area on part of the image to be enlarged or reduced. In the case of checking map details, the user can specify the area necessary for that check as the editing area.

On the specification screen K1 there is an area A1 for specifying the points of interest, and an area A2 for specifying the magnification rate for enlarging or reducing the image. The points of interest become the reference points for setting the rectangular shaped editing area.

In the area A1 of the specification screen K1 there is a text box T11 for specifying the number of points of interest. The number of points specified is usually 1 or a small number.

After specifying the number of points of interest, the user selects one of the three radio buttons R11, R12 or R13 that are located in the area A1. The radio button R11 corresponds to the case in which the cursor key on the control panel 12 or other pointing device is used to specify the points of interest on the target image. The pointer that is displayed on the target image is moved using the pointing device, and the point of interest is specified with that pointer. The coordinates of the pointer at that time are acquired as the coordinates of the point of interest. The button R12 corresponds to the case in which the coordinates of a point of interest are entered as numerical values in the text boxes T12 and T13. The value entered in the box T12 is used as the X-coordinate and the value entered in the box T13 is used as the Y-coordinate. Also, the button R13 corresponds to the case in which the points of interest are specified by specifying data. As in the example shown in FIG. 5, by expressing a map using SVG format data, elements expressed by names such as ‘City A’, ‘Town D’, ‘School J’, ‘Park J’ and the like are contained in that data. When the button R13 is pressed, the element corresponding to the name entered in the text box 14 is found from the data, and the coordinates corresponding to the element are obtained as the coordinates of the specified point.

When two or more points of interest are specified, any one of the three methods can be used the same number of times as the number of points specified. For example, when two points of interest are to be specified, two points of interest used for setting two opposing points of vertices of the rectangle are specified. In this case, the area of that rectangle becomes the area of the image to be edited. In the case of using a pointing device to set a rectangular area on the map that includes ‘City A’ and ‘City C’, the user sequentially lines up the pointer on ‘City A’ and ‘City C’, and specifies those locations as points of interest. It is also possible to sequentially input the coordinates for ‘City A’ and ‘City C’, or to sequentially enter the text for ‘City A’ and ‘City C’ in the text box T14. Furthermore, it is also possible to use a different method each time.

After acquiring the coordinates for ‘City A’ (Ax, Ay) and the coordinates for ‘City C’ (Cx, Cy), the CPU 6 compares the values of the X-coordinate and Y-coordinate for both sets of coordinates. When the value of the X-coordinate Ax is less than the value of the X-coordinate Cx, and the Y-coordinate Ay is greater than the value of the Y-coordinate Cy, the coordinates of the two opposing points of the vertices of the rectangle are set as coordinate V1 (Ax−Δx, Cy−Δy) and coordinate V2 (Cx+Δx, Ay+Δy).

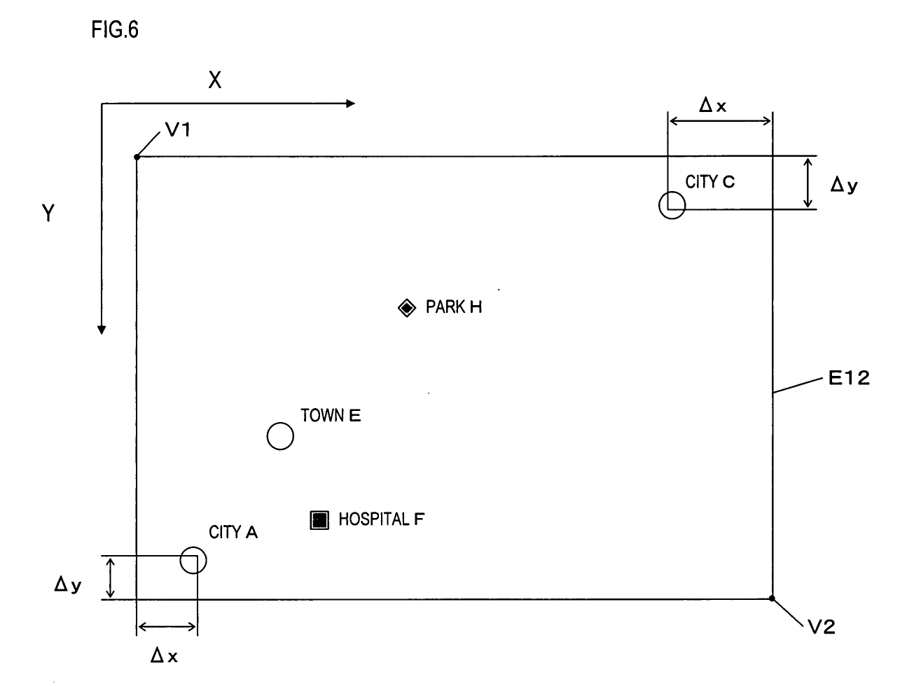

In this example, as shown in FIG. 6, the CPU 6 sets the area of the rectangle obtained from the coordinates V1 and V2 that include ‘City A’ and ‘City C’ as the editing area E12 (S6).

When three or more points of interest are specified, the CPU 6 sets the smallest rectangular area that includes all of the specified points, for example, as the editing area.

When only one point of interest is specified, it is possible to set the area of a rectangle that includes that specified point of interest as the editing area. That rectangular area can also be set by dividing the target image into a plurality of blocks, and selecting the block from those blocks that includes the point of interest, or the CPU 6 can set the rectangular area based on the coordinates of the vertices of the target image and the coordinates of the point of interest, or can it can be set by some other method. The dotted lines in FIG. 5 show an example in which the rectangular area is set based on the coordinates of the vertices of the target image and the coordinates of the point of interest. The editing area E56 is set based on the coordinates of vertices V5 and V6 from among the vertices V5 to V8 of the target image Z58 and the coordinates of the point of interest (here, these are the coordinates of ‘City A’).

The rectangular area is displayed on the control panel 12, and the user is able to change the specifications as needed according to that display.

In this example, the user can designate the contents for editing the image inside the area set in the target image in area A2 on the specification screen K1. The user uses the control panel 12 to enter the magnification rate in the text box T21 in area A2 for enlarging or reducing the image. When a value greater than 100%, such as 115%, is entered in the text box T21, the image inside the set area is specified by the user to be enlarged, and when a value less than 100%, such as 75%, is entered, the image is specified to be reduced. When the value entered into the text box T21 is 100%, editing to change the size of the image in the set area is not performed. In the case where an instruction to enlarge or reduce the image is already given and the user does not specify the magnification rate, the user is prompted to enter the magnification rate, or the printer 1 automatically sets the magnification rate.

In this embodiment, the determination unit 24 determines details of editing of the image inside the set area. When the user gives an instruction for performing editing such as the specifications in area A2, the details are set based on that instruction.

Also, the determination unit 24 determines details of editing the image outside the set area of the target image based on an editing instruction from the user to edit the image inside an area set in part of the target image, and based on the obtained data of the paper. When there is an instruction from the user to enlarge the image inside the set area, the determination unit 24 makes a determination, for example, to reduce the image outside the set area in accordance to that enlargement. Even though there is an instruction to enlarge the image inside the editing area, it is also possible to set other editing contents for the image outside the set area. In that case, the determination unit 24 determines whether or not that image is to be edited using other contents, and only when it determines that the image is not to be edited using other contents, does it set to perform reduction according to the enlargement. Determining whether to perform reduction in accordance to the enlargement, or whether to perform editing using other contents can all be performed according to instructions from the user. Here, this determination function is performed by the CPU 6 according to instructions from the program 9.

When the user specifies the magnification rate for enlarging or reducing the image in area A2 on the specification screen K1, the CPU 6 calculates the size of the image inside the set area when enlarged or reduced using that magnification rate. The CPU 6 then compares the size of the printing area on the paper used for printing with the calculated size, and when the size of the printing area is less than the calculated size, it determines only editing contents for editing the image inside the set area. The CPU 6 determines to cut out only the part of the image inside the set area that is enlarged or reduced that will fit in the printing area.

In the case where the size of the printing area is greater than the calculated size, the CPU 6 determines editing contents for the image outside the set area on the target image. When enlarging the image inside the set area, the CPU 6 determines whether to also enlarge the image outside the set area, or to reduce the image outside the set area, so it references the specifications from the user entered using the radio buttons R21 or R22 in the area A2. The user selects either button R21 or R22.

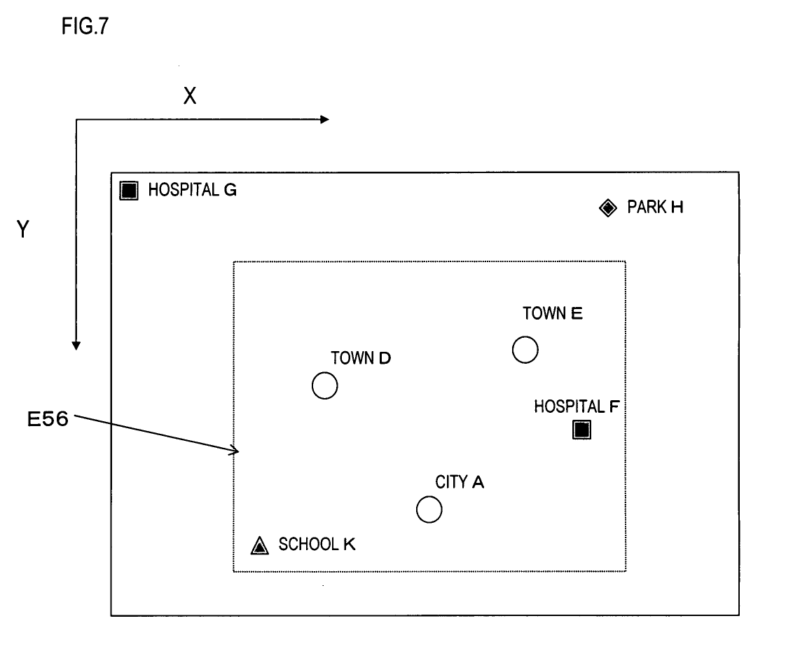

When the button R21 is selected, the CPU 6 also enlarges the image outside the set area using the same magnification rate as the image inside the set area, or in other words, determines to enlarge the entire target image at the specified magnification rate. When the image inside the set area does not fit in the printing area when enlarged, the CPU 6 performs a setting to cut out just the part of the image that will fit in the printing area. FIG. 7 is an example that shows the area E56 indicated by the dotted lines in FIG. 5, and the image in the area that is cut out from the area outside the set area. In this image, the scale of both areas does not change, however in order to cut out the area, the image does not include ‘City C’ or ‘School J’.

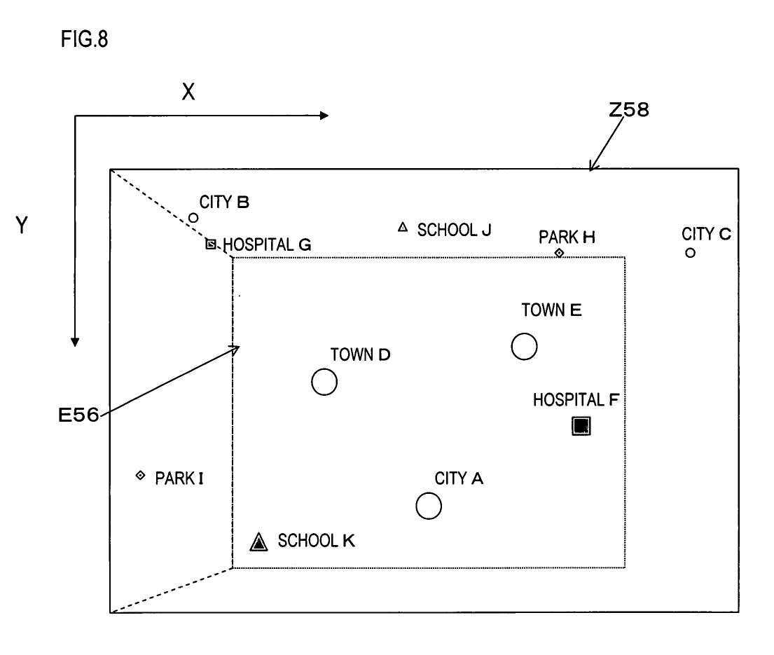

When the button R22 is selected, the CPU 6 determines the reduction of the image outside the set area using a magnification rate that is in accordance to the magnification rate used for enlarging the image inside the set area. This magnification rate for reduction is set based on the size of the printing area and the magnification rate used for enlargement, and is set such that the entire area of the target image will fit inside the printing area. FIG. 8 is an example of an image in which the image inside the area E56 indicated by the dotted lines in FIG. 5 is enlarged, and the image outside that area is reduced. In this image, the scale of both areas is different, however, the entire target image Z58 is included in the image.

When the size of the printing area is larger than the calculated size, even when the image inside the set area is reduced or when the image inside the set area is enlarged, it is possible to similarly determine editing contents for the image outside the set area. When the user selects the button R22, the CPU 6 determines the enlargement of the image outside the set area at a magnification rate in accordance to the magnification rate of reduction. Instead of the image outside the set area, it is also possible to place attribute data for the target image or an image other than the target image in the printing area.

Moreover, even in the case where no magnification rate is specified in the area A2 on the specification screen K1 and the magnification rate is set automatically, it is possible to similarly determine editing contents for the image outside the set area.

In this way, the CPU 6 determines the editing contents for the image outside the set area of the target image (S7).

A creation unit 25 creates printing data from the data of the target image based on the editing contents and setting for the image inside the set area of the target image. Here, the editing contents for the image inside the set area are also set by the determination unit 24 based on instructions from the user, so the creation unit 25 creates printing data based on the determination by the determination unit 24. The CPU 6 performs this creation function according to an instruction from the program 9.

When there is an instruction from the user to edit the target image, after determining the details of the editing of the image inside the set area and the image outside the set area, the CPU 6 creates printing data from the data of the target image according to the details of the editing (S8). The CPU 6 outputs the printing data to the print engine 3 to print on the paper the image edited according to the instruction given from the user and edited according to the determination based on the instruction.

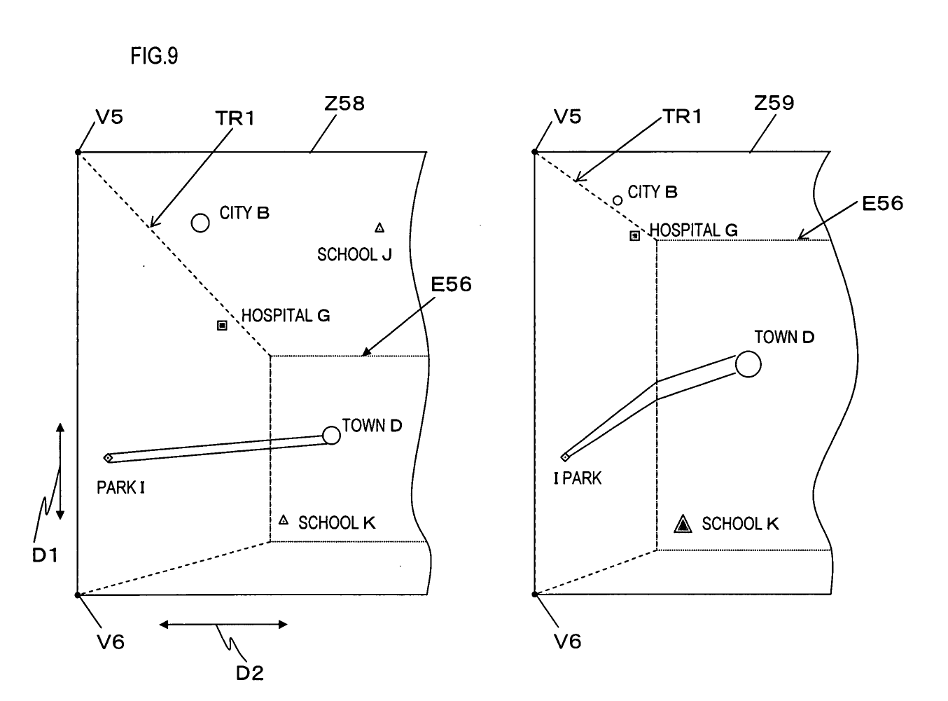

For example, when the image shown in FIG. 8 is printed, not only is the user able to check in detail the portion that was specified to be enlarged, but is also able to check the other portion in a form that does not greatly hinder the information. FIG. 9 shows a comparison between the target image and the edited image. As shown in the figure, the trapezoid TR1 that is expressed by the edges that connect the two vertices of the printing area and the corresponding vertices of the edited area E56 becomes flatter in the edited image Z59 than in the target image Z58. Not only the image inside the set area, but also the image outside the set area is enlarged by the specified magnification rate in the direction D1 along the boundary of the set area. On the other hand, the image outside of the set area is reduced in the direction D2 going away from the set area. When there is a straight road on the map that is uniform in width and that connects ‘Park I’ and ‘Town D’, the road becomes shorter outside the set area in the edited image, and also becomes narrower in the direction going away from the set area. In the target image, when that road is at an angle with respect to the boundary, it bends at the boundary in the edited image but does not become divided. Therefore, even in the printed image, it is possible for the user to know that that the road passing though ‘Town D’ goes toward ‘Park I’.

In this way, with the printer of this embodiment, it is possible to print the image for which the automatic editing adjusted to the instruction from the user is performed.

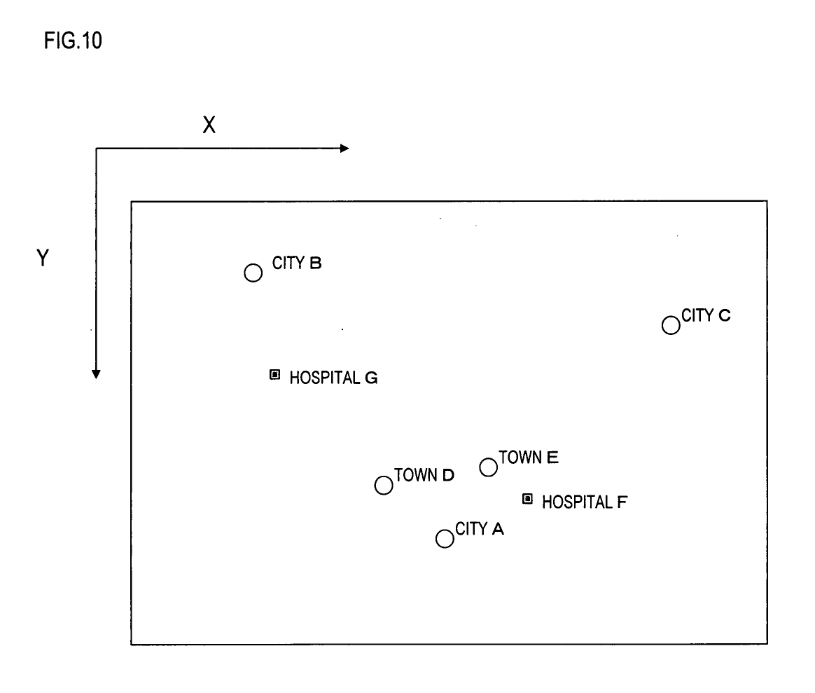

In this example, the target image was enlarged or reduced, however it is also possible to perform other editing of the image such as moving or rotating the image. Furthermore, by using metadata that contains the data for the target image, data notation in markup language, or text data, it is also possible to add editing to the contents of the target image. Also, in the printing data creation apparatus, it is possible to have the creation unit 25 include just data selected by the user from the data of the target image in the printing data. For example, in SVG-format data, it is possible to define a tag for each type of data, and to divide each type of data into layers. The area A3 in the specification screen K1 shown in FIG. 4 is used by the user to select the type of data. A list of the types of data expressed on the map is displayed in a list box L31. Here, a unique ID is entered for each type of facility on the map using a ‘g’ element in the SVG-format data. In order to display that list, the CPU 6 reads IDs such as ‘Hospital’, ‘Park’, ‘School’ or the like. The user uses registration buttons B31 or B32 to specify the items selected from the types of facilities contained in the list. When the registration button B32 is pressed, all of the types of facilities contained in the list are selected. The selected types of facilities are displayed in the text box T31. The CPU 6 then searches the target image data for the elements in which the IDs corresponding to the types of facilities displayed in the text box T31 are entered, and creates an edited image of the target image according to the result. FIG. 10 shows an example of an edited image for the target image Z58 shown in FIG. 5 when ‘Hospital’ is selected as the type of facility. The facilities ‘Park’ and ‘School’ are eliminated from this edited image. This kind of editing can be performed together with editing such as enlarging or reducing the image. Also, this editing can be performed for just inside the set area, or can be performed for the entire target image; and furthermore, the selected data for inside the set area and outside the set area can be different.

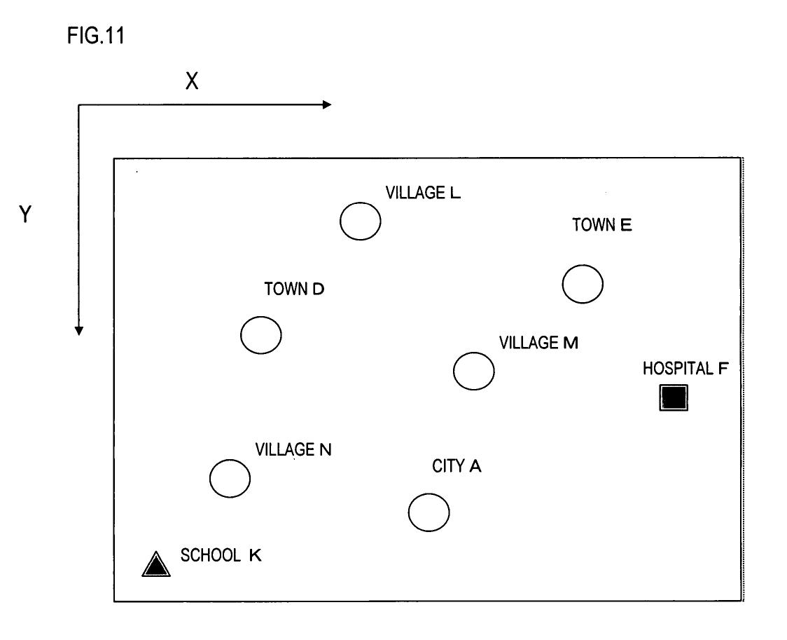

It is possible to combine editing the contents by selecting the type of data with editing such as enlarging or reducing the image. When combined with enlarging or reducing the image, it is also possible to automatically select the type of data. In that case, the creation unit 25 selects data to be included in the printing data based on the specified magnification rate for enlarging or reducing the image. In the case of SVG-format data, an ID that is unique for each magnification rate, such as same-size magnification or 2× magnification is used in the selection. When the magnification rate is specified in the text box T21, the CPU 6 references the magnification rate and searches for a ‘g’ element in which the ID corresponding to that magnification rate is entered. Also, according to the result of the search, the CPU 6 selects data to be contained in the printing data and creates the printing data. When 2× magnification is selected as the magnification rate, the CPU 6 creates printing data from the ‘g’ element in which same-size magnification and 2× magnification are entered. FIG. 11 shows an example of an edited image for the target image Z58 shown in FIG. 5 when 2× magnification is specified. The location names ‘Village L’, ‘Village M’ and ‘Village N’ that were not included in the target image at same-size magnification are included in this edited image.

When reducing the image, it becomes difficult for the user to see the text for the location names when that text become congested on the map, so some of the location names that are contained in the same-size magnification target image are omitted.

By selecting data to be contained in the printing data based on the specified magnification rate in this way, the user is able to supply additional information and improve the ability to see the information.

Also, in the example described above, printing data was created from data recorded on an SD card, however, the invention is not limited to this. This printer has a USB (Universal Serial Bus) interface 13. This interface 13 is located in the host controller so it is possible to provide a printing service to the connected devices. For example, by connecting a digital camera to the printer 1, the printer 1 prints the data received from that digital camera. As shown in FIG. 1, by connecting a personal computer to the printer 1 using a USB cable 15, the printer 1 is able to print data received from that personal computer 14.

The editing instruction from the user can be received by the personal computer 14. A printer driver on the computer 14 receives the editing instruction. By communicating with the program 9, the printer driver sends the instructions from the user to the program 9, and receives data from the program 9 to perform processing according to the received data.

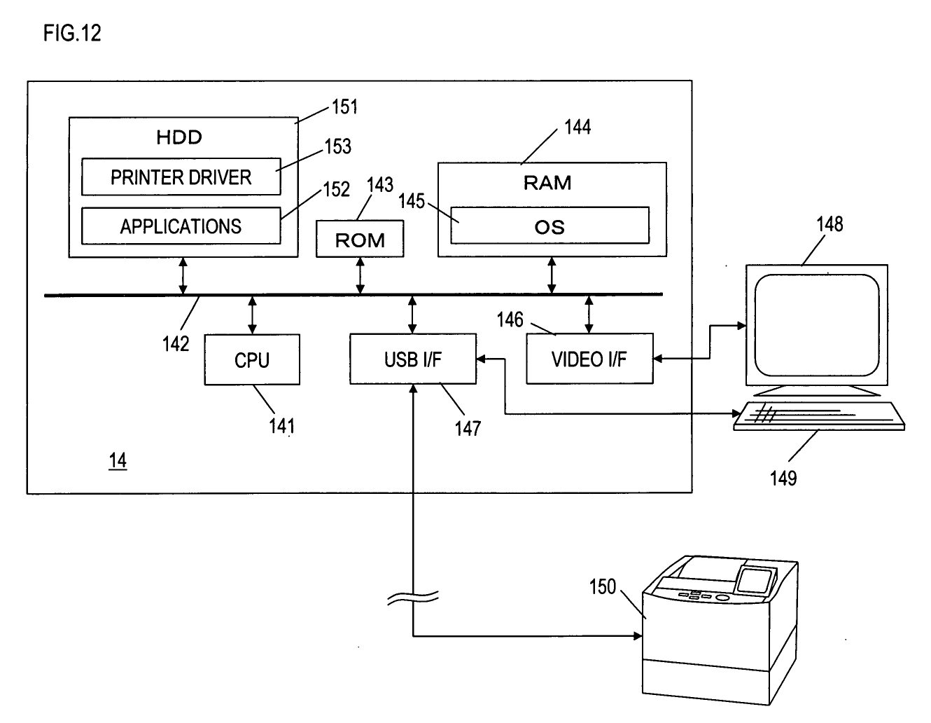

Moreover, the computer 14 can also creates printing data. For example, as shown in FIG. 12, the computer 14 comprises a CPU 141 and bus 142. The CPU 141 is connected to a ROM 143 and RAM 144 via the bus 142. When the computer 14 is activated according to an instruction from the program stored in the ROM 143, the CPU 141 operates part or all of the OS (Operating System) 145 in the RAM 144.

A video interface 146 and USB interface 147 are also connected to the bus 142. The video interface 146 displays images on a display 148 according to instructions from the CPU 141. It is possible to use a CRT (Cathode Ray Tube) or LCD (Liquid Crystal Display) as the display 148. The USB interface 147 can be used to connect peripheral devices to the computer 141. Here, an input device 149 and printer 150 are connected to the computer 141. In addition to a keyboard, a mouse or trackball can be used as another input device.

In addition to the ROM 143 and RAM 144, a HDD (Hard Disk Drive) 151 is also connected to the bus 14. Application programs 152, printer driver 153 and other files are stored on this HDD 151. The application programs 152 are programs operated by the OS 145 such as a word processing program, spreadsheet program, graphics editing program or the like. When the user uses the input device 149 to send an instruction to use an application program 152, the CPU 141 reads the application program 152 file from the HDD 151 according to an instruction from the OS 145, and uses the RAM 144 to operate that application program 152. The user can print the processing results of the application program 152 using the printer 150. When a printing request is received from the application program 152, the printer driver 153 uses the functions of the OS 145 as necessary and creates printing data. The created printing data is sent from the computer 14 to the pr inter 150, and printed by the printer 150. In this case, hardware such as the CPU 141 and RAM 144 of the computer 14 function as the printing data creation apparatus of this invention. When the CPU 141 of the computer 14 operates according to an instruction from the printer driver 153, that computer 14 functions as described above and executes the corresponding procedure. According to an instruction from the printer driver 153, the CPU 141 can acquire data from the printer 150 related to the paper that can be used by the printer 150 or paper that can be used in printing. Instead of the computer 14, it is also possible to use a portable telephone or other portable terminal to create printing data.

An example of data for a map in SVG format was explained, however, the data of the target image is not limited to this. It is also possible to create printing data from data for a CAD drawing, architectural drawing for an architectural structure, a table, or other image. The invention can also be used to enlarge part of a CAD drawing or table in order to check details.

Moreover, the editing area can be automatically set by the setting unit 23. When the editing area is set automatically, the case when there is no editing instruction from the user for an image inside the set area is also possible. When the user does not explicitly give an instruction for an image inside the set area, a method in which the printer 1 prompts the user to edit the image may be preferable. For example, in HTML format or XML format data, there is no information that indicates page breaks. In that case, there is a possibility that one figure will be divided and recorded on a plurality of sheets of paper.

Therefore, it is possible to have a judgment unit 26 located in the printing data creation apparatus. The judgment unit 26 determines whether or not to edit the layout of the image on the paper based on the format of the data for the target image. When the layout is to be edited, the setting unit 23 sets an area based on the data for the target image, and even when there is no editing instruction from the user for the image inside the set area, the creation unit 25 creates printing data based on the editing instruction for the layout. The CPU 6 can also perform these functions according to instructions from the program 9.

The CPU 6 identifies the format of data for which there is a printing instruction from the user based on extensions or metadata. Here, a table 16 inside the ROM 7 is referenced in order to perform the judgment. The data format is registered in this table. Here, the registered format is format that does not contain information that indicates the page breaks. The CPU 6 determines to edit the layout of the image on the paper only when the identified format is registered in the table 16.

When the CPU 6 determines to edit the layout of the image on the paper, the CPU 6 sets the editing area based on attribute data for the target image. In the case of SVG-format data, the CPU 6 sets the editing area based on the values of the width attribute and height attribute of the SVG element of the route.

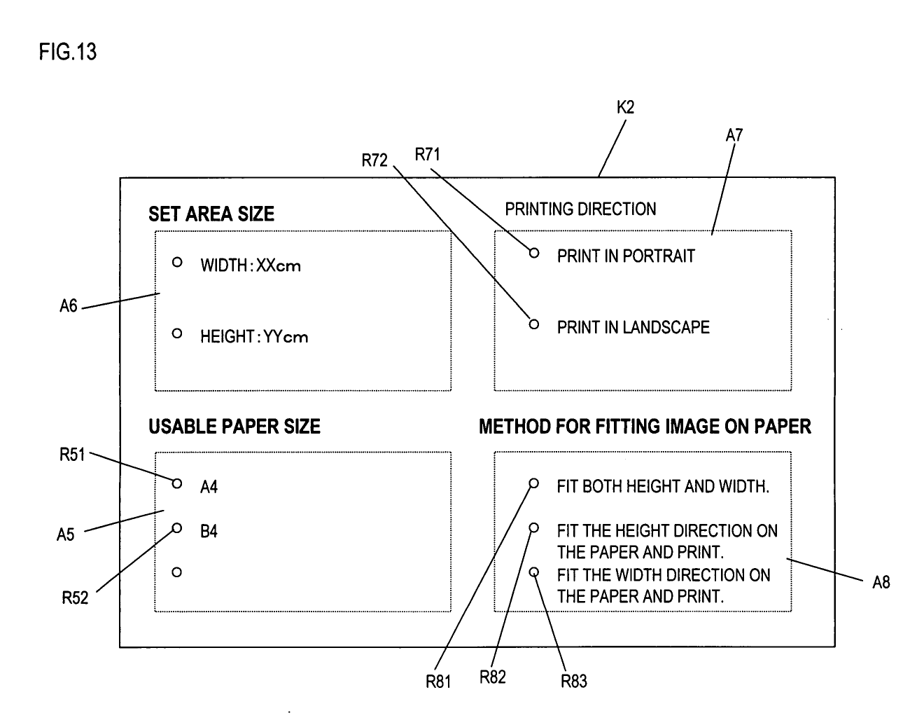

Also, the CPU 6 acquires the size of the paper that can be used by the printer 1, and based on that result, displays the layout-specification screen on the control panel 12. This layout-specification screen is a screen for the user to specify the editing contents for the layout. FIG. 13 shows an example of this screen. The usable paper size is displayed in the area A5 on that specification screen K2. The radio buttons R51 and R52 are used by the user to specify the paper to be used in printing. The size of the set area is displayed in the area A6.

The user references the tables in the areas A5 and A6, and gives editing instructions for the layout using the areas A7 and A8. In area A7, the radio buttons R71 and R72 are used to specify the direction of the paper. By pressing the button R71, printing in portrait is specified, and by the pressing button R72, printing in landscape is specified. In the area A8, the buttons R81, R82 and R83 are used by the user to specify the method for aligning the image on the paper. By the pressing button R81, the height or width of the image inside the set area is specified to be enlarged or reduced in order to fit in the printing area of the paper to be used for printing. By the pressing button R82, changing the height of the image inside the set area is specified. By the pressing button R83, adjusting the width of the image inside the set area is specified. These specifications can be performed by the user so that the image inside the set area fits in the printing area.

The CPU 6 creates printing data from the data for the target image based on the specifications. In this way, the user is able to give editing instructions for the layout before printing data such as data in HTML format even when there is no instruction to edit the image inside the set area. As a result, it is possible to avoid performing printing unnecessarily.

Instead of the layout-specification screen, it is also possible to have the user select a layout from among automatically extracted layout candidates. In order for that, a layout candidate extraction unit 27 is located in the printing data creation apparatus. The layout candidate extraction unit 27 sets a layout candidates based on the area setting and data related to the acquired usable paper. The CPU 6 can also perform this function according to an instruction from the program 9.

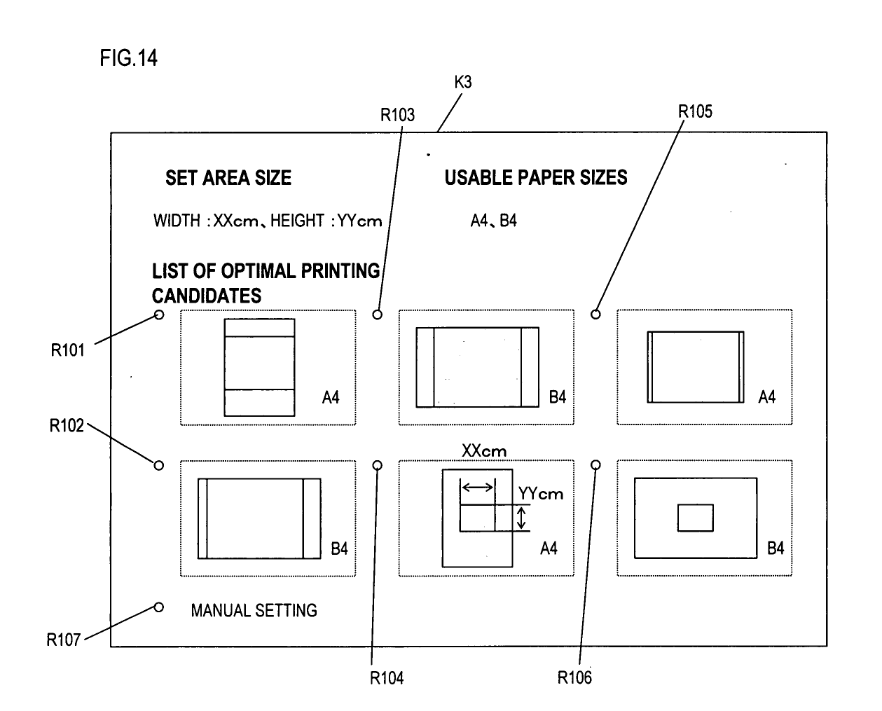

Together with setting the area based on attribute data for the target image, the CPU 6 acquires data related to the usable paper, and then sets the layout candidates based on the area setting, paper size and direction. The layout candidates are given the size and direction of the paper for which the image inside the set area will fit in the printing area. After the layout candidates are set, the CPU 6 displays a screen on the control panel 12 for the user to select a candidate. FIG. 14 shows an example of the selection screen. Similar to the layout specification screen K2, the size of the set area and size of the usable paper are displayed on this selection screen K3. Also, a list of images showing the layout candidates is included. The image of each candidate shows the location of the image inside the set area for the corresponding paper and direction of that paper. In this example, the paper size is displayed using text near the image of each candidate. The user selects a printing layout from the list by pressing one of the buttons R101 to R106. By pressing the radio button R107, it is also possible for the user to specify the layout on the layout specification screen K2.

After the printing layout has been selected, the CPU 6 creates printing data from the data of the target image based on the layout. In this way it is possible for the user to easily give instructions for editing the layout.

By having the computer operate software corresponding to the program 9, such as the printer driver 153, it is possible for the computer to perform this kind of function as well, and to execute the corresponding procedure.

The instructions from this kind of printing data creation program can be given to the computer by using a computer readable medium. It is possible to use various kinds of media such as a recording medium or transmission medium as the computer readable medium. For example, by expressing the program instructions as an electrical signal, optical signal, magnetic signal or the like, and placing and transmitting the signal on a carrier wave, it is possible to provide the program to a third party using a transmission medium such as coaxial cable, copper wire, or optical fiber. It is possible to use wireless transmission or infrared transmission to transmit the signal. As the recording medium, it is also possible to use an optical medium such as CD-ROM or DVD-ROM, or a magnetic medium such as a floppy disk, or a semiconductor memory such as a flash memory or RAM.

Instead of the printer 1 it is also possible to apply this invention to other apparatuses such as a facsimile or copier.

The printing data creation apparatus, printing data creation method and printing data creation program of this invention are effective in making it possible to print images that have been adjusted and edited according to editing instructions from the user, and can be used for a printer, facsimile, copier or printer driver.

The disclosure of Japanese Patent Application No. 2004-9297 filed Jan. 16, 2004 including specification, drawings and claims is incorporated herein by reference in its entirety.

In the disclosure, there is shown and described only the preferred embodiment of the invention, but, as aforementioned, it is to be understood that the invention is capable of use in various other combinations and environments and is capable of changes or modifications within the scope of the inventive concept as expressed herein.

1. A printing data creation apparatus comprising:
a setting unit configured to set an editing area on a target image;
a unit configured to acquire data of a paper to be used in printing;
a determination unit configured to, based on an instruction from a user for editing an image inside an area set on a part of the target image and based on the acquired data of the paper, determine details of editing of an image outside the set area on the target image; and
a creation unit configured to create printing data from data of the target image based on the instruction and the determination.

2. A printing data creation apparatus according to claim 1, wherein the determination unit, upon receiving an instruction from a user to enlarge an image inside the set area, determines to reduce an image outside the set area according to the enlargement, and
the creation unit creates printing data corresponding to all areas of the target image.

3. A printing data creation apparatus according to claim 1, further comprising a control unit configured to be used by a user to specify an editing area, and
wherein the setting unit sets an editing area on a target image based on the specification.

4. A printing data creation apparatus according to claim 3, wherein the setting unit sets an editing area based on one or more points specified on the target image, or based on data specified from data for the target image.

5. A printing data creation apparatus according to claim 1, wherein the creation unit includes only data selected by a user from among data for the target image, on the printing data.

6. A printing data creation apparatus according to claim 1, wherein the creation unit selects data included on the printing data, based on a specified magnification rate for enlarging or reducing an image.

7. A printing data creation apparatus according to claim 1, further comprising a unit configured to judge whether or not to edit a layout of an image on a paper, based on a format of data of the target image, and
wherein the setting unit sets an area based on data for the target image when the layout is to be edited, and
the creation unit creates printing data based on an instruction to edit the layout even receiving no instruction from a user for editing an image inside a set area.

8. A printing data creation apparatus according to claim 7, further comprising a unit configured to determine layout candidates based on the setting and based on acquired data of a paper, and
wherein the creation unit creates printing data based on a layout selected from among the candidates.

9. A printing data creation apparatus comprising:
a unit configured to set an editing area on a target image;
a unit configured to acquire data of a paper to be used in printing;
a unit configured to, upon receiving an instruction from a user to enlarge an image inside an area set on a part of the target image, reduce an image outside the set area according to the enlargement, based on the acquired data of the paper; and
a unit configured to create printing data from data of the target image based on the enlargement instruction and reduction setting.

10. A printing data creation method comprising the steps of:
setting an editing area on a target image;
acquiring data of a paper to be used in printing;
based on an instruction from a user for editing an image inside an area set on a part of the target image and based on the acquired data of the paper, determining details of editing of an image outside the set area on the target image; and
creating printing data from data of the target image based on the instruction and the determination.

11. A printing data creation method according to claim 10, wherein said step of determining the details of editing comprises the step of, upon receiving an instruction from a user to enlarge an image inside the set area, determining to reduce an image outside the set area according to the enlargement, and said step of creating the printing data comprises the step of creating printing data corresponding to all areas of the target image.

12. A printing data creation method according to claim 10, wherein said step of setting the editing area comprises the step of setting the editing area for the target image based on a specification from a user.

13. A printing data creation method according to claim 12, wherein said step of setting the editing area comprises the step of setting the editing area based on one or more points specified on the target image, or based on data specified from data for the target image.

14. A printing data creation method according to claim 10, wherein said step of creating the printing data comprises the step of including only data selected by a user from among data for the target image, on the printing data.

15. A printing data creation method according to claim 10, wherein said step of creating the printing data further comprises the step of selecting data included on the printing data, based on a specified magnification rate for enlarging or reducing an image.

16. A printing data creation method according to claim 10, further comprising the step of judging whether or not to edit a layout of an image on a paper, based on a format of data of the target image, and
wherein said step of setting the editing area comprises the step of setting an area based on data for the target image when the layout is to be edited, and said step of creating the printing data comprises the step of creating printing data based on an instruction to edit the layout even receiving no instruction from a user for editing an image inside a set area.

17. A printing data creation method according to claim 16, further comprising the step of determining layout candidates based on the setting and based on the acquired data of the paper, and
wherein said step of creating the printing data comprises the step of creating the printing data based on a layout selected from among the candidates.

18. A printing data creation method comprising the steps of:
setting an editing area on a target image;
acquiring data of a paper to be used in printing;
upon receiving an instruction from a user to enlarge an image inside an area set on a part of the target image, reducing an image outside the set area according to the enlargement, based on the acquired data of the paper; and
creating printing data from data of the target image based on the enlargement instruction and reduction setting.

19. A printing data creation program causing a computer to perform the steps of:
setting an editing area on a target image;
acquiring data of a paper to be used in printing;
based on an instruction from a user for editing an image inside an area set on a part of the target image and based on the acquired data of the paper, determining details of editing of an image outside the set area on the target image; and
creating printing data from data of the target image based on the instruction and the determination.

20. A printing data creation program according to claim 19, wherein said step of determining the details of editing comprises the step of, upon receiving an instruction from a user to enlarge an image inside the set area, determining to reduce an image outside the set area according to the enlargement, and said step of creating the printing data comprises the step of creating printing data corresponding to all areas of the target image.

21. A printing data creation program according to claim 19, wherein said step of setting the editing area comprises the step of setting the editing area for the target image based on a specification from a user.

22. A printing data creation program according to claim 21, wherein said step of setting the editing area comprises the step of setting the editing area based on one or more points specified on the target image, or based on data specified from data for the target image.

23. A printing data creation program according to claim 19, wherein said step of creating the printing data comprises the step of including only data selected by a user from among data for the target image, on the printing data.

24. A printing data creation program according to claim 19, wherein said step of creating the printing data further comprises the step of selecting data included on the printing data, based on a specified magnification rate for enlarging or reducing an image.

25. A printing data creation program according to claim 19, further comprising the step of judging whether or not to edit a layout of an image on a paper, based on a format of data of the target image, and
wherein said step of setting the editing area comprises the step of setting an area based on data for the target image when the layout is to be edited, and said step of creating the printing data comprises the step of creating printing data based on an instruction to edit the layout even receiving no instruction from a user for editing an image inside a set area.

26. A printing data creation program according to claim 25, further comprising the step of determining layout candidates based on the setting and based on the acquired data of the paper, and
wherein said step of creating the printing data comprises the step of creating the printing data based on a layout selected from among the candidates.

27. A printing data creation program causing a computer to perform the steps of:
setting an editing area on a target image;
acquiring data of a paper to be used in printing;
upon receiving an instruction from a user to enlarge an image inside an area set on a part of the target image, reducing an image outside the set area according to the enlargement, based on the acquired data of the paper; and
creating printing data from data of the target image based on the enlargement instruction and reduction setting.

28. A computer readable storage medium storing a printing data creation program causing a computer to perform the steps of:
setting an editing area on a target image;
acquiring data of a paper to be used in printing;
based on an instruction from a user for editing an image inside an area set on a part of the target image and based on the acquired data of the paper, determining details of editing of an image outside the set area on the target image; and
creating printing data from data of the target image based on the instruction and the determination.

29. A computer readable storage medium storing a printing data creation program according to claim 28, wherein said step of determining the details of editing comprises the step of, upon receiving an instruction from a user to enlarge an image inside the set area, determining to reduce an image outside the set area according to the enlargement, and said step of creating the printing data comprises the step of creating printing data corresponding to all areas of the target image.

30. A computer readable storage medium storing a printing data creation program according to claim 28, wherein said step of setting the editing area comprises the step of setting the editing area for the target image based on a specification from a user.

31. A computer readable storage medium storing a printing data creation program according to claim 30, wherein said step of setting the editing area comprises the step of setting the editing area based on one or more points specified on the target image, or based on data specified from data for the target image.

32. A computer readable storage medium storing a printing data creation program according to claim 28, wherein said step of creating the printing data comprises the step of including only data selected by a user from among data for the target image, on the printing data.

33. A computer readable storage medium storing a printing data creation program according to claim 28, wherein said step of creating the printing data further comprises the step of selecting data included on the printing data, based on a specified magnification rate for enlarging or reducing an image.

34. A computer readable storage medium storing a printing data creation program according to claim 28, further comprising the step of judging whether or not to edit a layout of an image on a paper, based on a format of data of the target image, and
wherein said step of setting the editing area comprises the step of setting an area based on data for the target image when the layout is to be edited, and said step of creating the printing data comprises the step of creating printing data based on an instruction to edit the layout even receiving no instruction from a user for editing an image inside a set area.

35. A computer readable storage medium storing a printing data creation program according to claim 34, further comprising the step of determining layout candidates based on the setting and based on the acquired data of the paper, and
wherein said step of creating the printing data comprises the step of creating the printing data based on a layout selected from among the candidates.

36. A computer readable storage medium storing a printing data creation program causing a computer the steps of:
setting an editing area on a target image;
acquiring data of a paper to be used in printing;
upon receiving an instruction from a user to enlarge an image inside an area set on a part of the target image, reducing an image outside the set area according to the enlargement, based on the acquired data of the paper; and
creating printing data from data of the target image based on the enlargement instruction and reduction setting.
